(19) United States
(12) Patent Application Publication
(10) Pub. No.: US 2024/0342935 A1
(43) Pub. Date: Oct. 17, 2024

(54) SYSTEM FOR BODY-HAIR REMOVAL IN HARD TO ACCESS LOCATIONS

(71) Applicant: Ayhan ERTEN, Ulm (DE)

(72) Inventor: Ayhan ERTEN, Ulm (DE)

(21) Appl. No.: 18/752,686

(22) Filed: Jun. 24, 2024

Related U.S. Application Data
(63) Continuation of application No. PCT/EP2022/087531, filed on Dec. 22, 2022.

(30) Foreign Application Priority Data
Dec. 23, 2021 (DE) 10 2021 134 444.1

(51) Int. Cl. B26B 21/40; A45D 26/00

(52) U.S. Cl. CPC B26B 21/4056; B26B 21/4043; B26B 21/4081; A45D 2026/008

(57) ABSTRACT

A system for removing body hair, having a head unit which comprises a bearing surface for bearing on the skin, at least one electrically operated device for depilation or epilation of the body hair being present on the bearing surface, an electrical storage for electrically supplying the device for depilation or epilation, a communication module and a position sensor and/or a speed sensor being integrated in the head unit. The communication module is set up to establish a communication link with a further communication module of a control unit and to transmit the data of the position sensor and/or the speed sensor to the control unit. The control unit is set up to detect the position of the head unit on the basis of the data of the position sensor and/or the speed sensor and to evaluate the points at which depilation or epilation has already taken place.

This nonprovisional application is a continuation of International Application No. PCT/EP2022/087531, which was filed on Dec. 22, 2022, and which claims priority to German Patent Application No. 10 2021 134 444.1, which was filed in Germany on Dec. 23, 2021, and which are both herein incorporated by reference.

### BACKGROUND OF THE INVENTION

### Field of the Invention

The invention relates to a system for removing body hair from hard-to-reach areas, in particular for removing body hair from the back of a user.

### Description of the Background Art

Body hair removal is equally common and popular with both men and women. Body hair removal is carried out for hygienic and/or aesthetic reasons. Body hair removal or body depilation refers to all methods that aim to remove body hair in parts or, in the case of full-body hair removal, completely. A distinction is made between the following hair removal methods: Depilation, by means of shaving, depilatory cream or scarfing; and epilation, for example by halawa (sugaring), warm wax, cold wax strips, epilator, tweezers or permanently by electric or laser epilation.

Epilating devices of this or a similar type are known, for example, from the prior publications U.S. Pat. Nos. 4,575,902 A, 4,960,422 A or 5,084,055 A, which are all herein included by reference. Two types of hair removal must be distinguished, namely the removal of hairs on the skin surface (depilation) and the removal of hairs by the roots (epilation). Motor-powered epilating appliances operate on the principle of gripping and clamping the hairs to be removed and extracting them from the skin by the roots by means of pincerlike clamping members opening and closing at periodic intervals. Extraction is accomplished by the pincerlike clamping members being moved rapidly away from the skin after gripping the hair or hairs. This movement of the clamping members away from the skin may be accomplished, for example, in that the clamping members are part of a rotary cylinder, being periodically moved towards and away from each other as the cylinder rotates.

DE 10 2009 051 777 A1 describes a body razor that has the shape of a rider with two razor blades. A loop is attached to both sides of this rider so that a user can easily shave hard-to-reach areas—such as the back—with the blades on the rider.

The removal of body hair in hard-to-reach areas regularly takes a lot of time using conventional methods. Especially in the back area, it has proven to be difficult to check whether the body hair has been removed from all areas.

### SUMMARY OF THE INVENTION

It is therefore an object of the present invention to provide a system for removing body hair from hard-to-reach areas, which overcomes the disadvantages associated with the prior art.

In an example, the system according to the invention for removing body hair in hard-to-reach areas comprises a head unit which comprises a bearing surface for bearing against the skin. At least one electrically operated device for depilation or epilation of body hair is provided on the bearing surface, whereby the device can be a shaver, a trimmer or an epilator. An electrical storage for the electrical supply of the device for depilation or epilation, a communication module and a position sensor and/or a speed sensor are integrated into the head unit. The communication module is set up to establish a communication link with another communication module of a control unit and to transmit the data of the position sensor and/or the speed sensor to the control unit. The control unit is set up to use the data from the position sensor and/or the speed sensor to detect the position of the head unit and to evaluate the points at which depilation or epilation has already taken place.

This allows the user to reliably and completely remove body hair from areas of the body that are difficult to access or difficult to see. The system is a perfect everyday helper for back hair removal.

Position sensors (also known as gyrometers/gyroscopes or angular rate sensors) are used in many different devices, for example in cell phones, cars, pedometers, games consoles, cameras, etc. The gyrometer does not measure the absolute acceleration, but the rotational speed of a body around an axis, or its angular velocity. Its name is derived from the gyroscope or gyroscope instrument, whose construction principle with microelectromechanical components is used for the measurement.

It is possible for one, two, three (x, y, z planes) or even six axis (3-axis gyroscope and 3-axis accelerometer) to detect the movements; the position values can then be output by means of a corresponding circuit, i.e. evaluated by the control unit and, if necessary, output to an output device.

For the communication link, for example, a communication interface (12C, SPI, . . . ) can be used, which is selected depending on the model used. The sensitivity with regard to changes in position and speed is extremely high and reliably detects even the smallest changes (e.g. 12 mg/digit).

An acceleration sensor (known as an accelerometer) can also be used. This determines the inertia of a moving mass. This seismic mass is arranged in a spring-loaded, movable manner and operates a sliding resistor with a sliding contact, for example. An acceleration sensor (accelerometer) therefore contains a spring-mounted weight for each spatial axis along which the acceleration is to be measured. In classic accelerometers, this weight moves in the opposite direction to the spring force. However, for the purpose of miniaturization, the use of a piezoelectric sensor, preferably a MEMS (Micro-Electro-Mechanical System), is preferred in order to determine a mass inertia along the individual spatial axes.

The control unit can be a component of or is a smartphone or a tablet and if the smartphone or the tablet, in particular the control unit, is set up to output the recorded positions on the display of the smartphone or the tablet. An application is installed on the mobile device, namely the smartphone or the tablet, which—when executed on the device—graphically displays and monitors the depilation or epilation process.

The mobile device, for example the smartphone or the tablet, can comprise a camera, and the control unit can be configured to output the captured positions of the head unit superimposed on an image of the user's back captured by the camera. In other words, the user's back can be photographed first, whereby the position of the head unit in the image is then determined and the data from the position sensor and/or the speed sensor is then used to visualize where the head unit is currently located and which areas still need to be depilated or epilated. The display takes place in real time, although there is preferably a wireless communication link between the mobile device and the head unit.

The control unit can be set up to determine the progress of the depilation or epilation using the image and the position data, and if the display is set up to show the progress graphically. If necessary, there may even be a time display indicating the time still required or the imminent completion of depilation or epilation.

In order to ensure a particularly good depilation or epilation result, a pressure sensor can be assigned to the device for depilation or epilation and if the control unit is set up to evaluate the contact pressure during depilation or epilation. This evaluation can then be used to detect the contact pressure of the head unit on the entire back area. For example, the contact pressure can be output on the display of the mobile device, in particular on the display of the smartphone or tablet. An acoustic and/or visual alarm signal can be emitted by the mobile device when the pressure falls below or exceeds the specified values. The contact pressure can therefore be used as a value for the quality of depilation or epilation, whereby the control unit and the display are set up to output this quality on the display.

In order to ensure rapid removal of body hair from large areas, such as the back, a plurality of electrically operated devices for depilation or epilation can be integrated into the head unit and the devices can be arranged offset to one another.

To make the system easier to use, two holding straps can be attached to the head unit. These holding straps offer quick and clean depilation or epilation on the user's back. The holding straps can be adjusted individually so that the head unit can be moved manually along the back.

To make the holding straps easier to handle, they can be fitted with a handle or hand loop at their free ends.

In order to ensure reliable depilation or epilation for all angles and growth directions of body hair in hard-to-reach areas of the body, the head unit with its bearing surface can have the shape of a flattened or elongated rotational ellipsoid. This results in an approximately oval and therefore aerodynamic shape, which can also glide easily over the user's shoulder blades, for example, and thereby ensures reliable and thorough depilation or epilation.

Instead of using holding straps, it is also possible for the head unit to be movably attached to a rail. For example, the rail can be attached to a wall with two or more than two holding points, in particular with suction cups, whereby the head unit can then be moved along the rail in order to reach the user's back completely.

Also, the head unit can be equipped with an electric drive device that can adjust the head unit along a rail.

To adjust the head unit along the rail, the control unit can optionally be set up to control the movement of the head unit along the rail, for example, in the manner of a remote control.

Sensors can also be used to evaluate and output the points at which depilation or epilation has already taken place. The contact pressure can be monitored via the optional pressure sensor and, if necessary, an acoustic and/or visual signal can be output on the display of the mobile device.

The head unit can be attached to a holding bracket so that the user can use this holding bracket to fully lower the back. The head unit can be detachably connected to the holding bracket, which makes it easier to clean. The holding bracket itself can be provided with one or more joints in order to be able to set and temporarily fix an optimum angular position. The holding bracket can also be made of a thermoplastically deformable material, for example, in order to be adapted to the physical conditions of the respective user.

The features and combinations of features mentioned above in the description as well as the features and combinations of features mentioned below in the description of the figures and/or shown alone in the figures can be used not only in the combination indicated in each case, but also in other combinations or on their own, without going beyond the scope of the invention. Thus, embodiments which are not explicitly shown or explained in the figures, but which emerge from the explained embodiments and can be produced by separate combinations of features, are also to be regarded as comprised by the invention and disclosed.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 is a schematic representation of a system for removing body hair from hard-to-reach areas, with the head unit shown in a side view;

FIG. 2 shows the system shown in FIG. 2, with the head unit shown in a top view;

FIG. 3 shows an enlarged side view of the head unit of the system shown in FIG. 1;

FIG. 4 shows a schematic representation of a system for removing body hair in hard-to-reach areas, with the head unit from FIG. 3 attached to a holding bracket; and

FIG. 5 shows a schematic representation of a system for removing body hair in hard-to-reach areas, whereby the head unit from FIG. 3 is fixed along a rail so that it can be moved.

### DETAILED DESCRIPTION

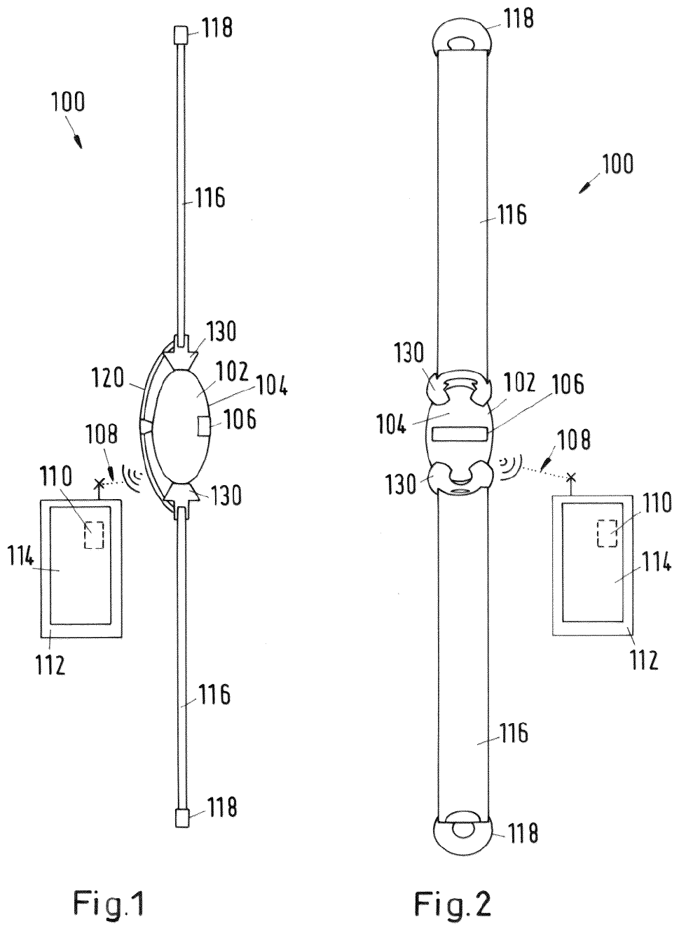

FIGS. 1, 2, 4 and 5 show a system 100 for removing body hair from hard-to-reach areas, in particular for removing body hair from the back of a user. The system 100 comprises a head unit 102 comprising a bearing surface 104 for bearing against the skin. An electrically operated device 106 for depilation or epilation of body hair is provided on the bearing surface 104. The device for depilation or epilation can be, for example, a shaver or also an epilator. Integrated into the head unit 102 is an electrical storage (for example, a battery, for electrically supplying the device 106 for depilation or epilation, a communication module, and a position sensor, and/or a speed sensor. These sensors detect the movement of the head unit 102. These sensors can also be used to detect the position of the head unit 102 in relation to the user's back. The communication module of the head unit 102 is set up to establish a communication link 108 with a further communication module of a control unit 110, and to transmit the data of the position sensor and/or the speed sensor to the control unit 110. The control unit is set up to use the data from the position sensor and/or the speed sensor to detect the position of the head unit 102 and to evaluate the points at which depilation or epilation has already taken place.

In the present case, the control unit 110 is part of a smartphone 112, whereby the smartphone 112 is set up to output the recorded positions on the display 114 of the smartphone 112. It should be noted that any other mobile device could also be used to implement a control unit 110, for example a tablet.

In the present case, the smartphone 112 comprises a camera, wherein the control unit 110—in particular the microprocessor of the smartphone 112—is set up to output the captured positions of the head unit 102 superimposed on an image of the user's back captured by the camera. The control unit 110 is thereby set up to determine the progress of the depilation or epilation using the image and using the position data. The progress is shown graphically on the display 114. For a good result of the depilation or epilation, a pressure sensor is assigned to the device 106 for depilation or epilation, wherein the control unit 110 is set up to evaluate the contact pressure during the depilation or epilation. In particular, the device 106 for depilation or epilation is spring-mounted so that the device 106 can move back axially; in other words, it can partially move into the housing of the head unit 102. The contact pressure is shown graphically on the display 114 of the smartphone 112. In addition, an acoustic and/or visual alarm signal is emitted if the contact pressure exceeds a predetermined limit pressure or falls below a predetermined limit pressure. The contact pressure is used, for example, as a value for the quality of the depilation or epilation, whereby this quality is also shown on the display 114.

In order to reliably reach all parts of the back and to be able to take into account all directions of growth of the body hair, the head unit 102 with its bearing surface 104 has the shape of a flattened or elongated ellipsoid of rotation. It is possible for the head unit 102 to have a plurality of electrically operated devices 106 for depilation or epilation, whereby the devices 106 are then arranged offset to one another in order to be able to depilate a larger area, for example a larger area of the back.

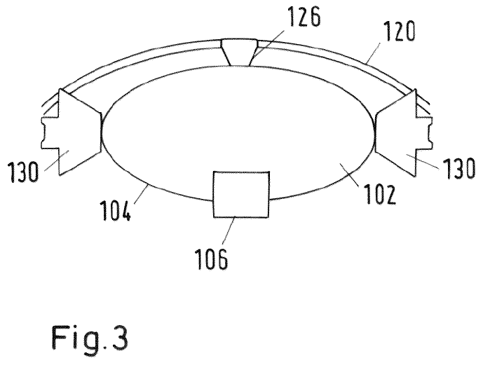

As can be seen from the variants of FIGS. 1 and 2, the system 100 shown here has two holding straps 116 attached to the head unit 102. The holding straps 116 have a hand loop 118 at their free ends, which facilitates operability. The holding straps 116 are hingedly fixed to the head unit 102 via a strap receiving part 130. In other words, the strap receiving part 130 connects the holding strap 116 to the head unit 102 in an articulated manner, in particular in a multidirectionally movable manner, which additionally improves the result of the depilation or epilation. The length of the holding strap 116 can be variably adjusted. FIGS. 1 and 3 show that a clamping bracket 120 is attached to the head unit 102. This clamping bracket 120 is connected to the head unit 102 via a fastening bar 126. The clamping bracket 120 rigidly connects the two ends of the holding straps 116 attached to the head unit 102. The clamping bracket 120 is preferably formed such that the mobility of the strap receiving parts 130 is maintained. In any case, the clamping bracket 120 ensures that the head unit 102 does not twist undesirably and that the bearing surface 104 always remains facing the back during use.

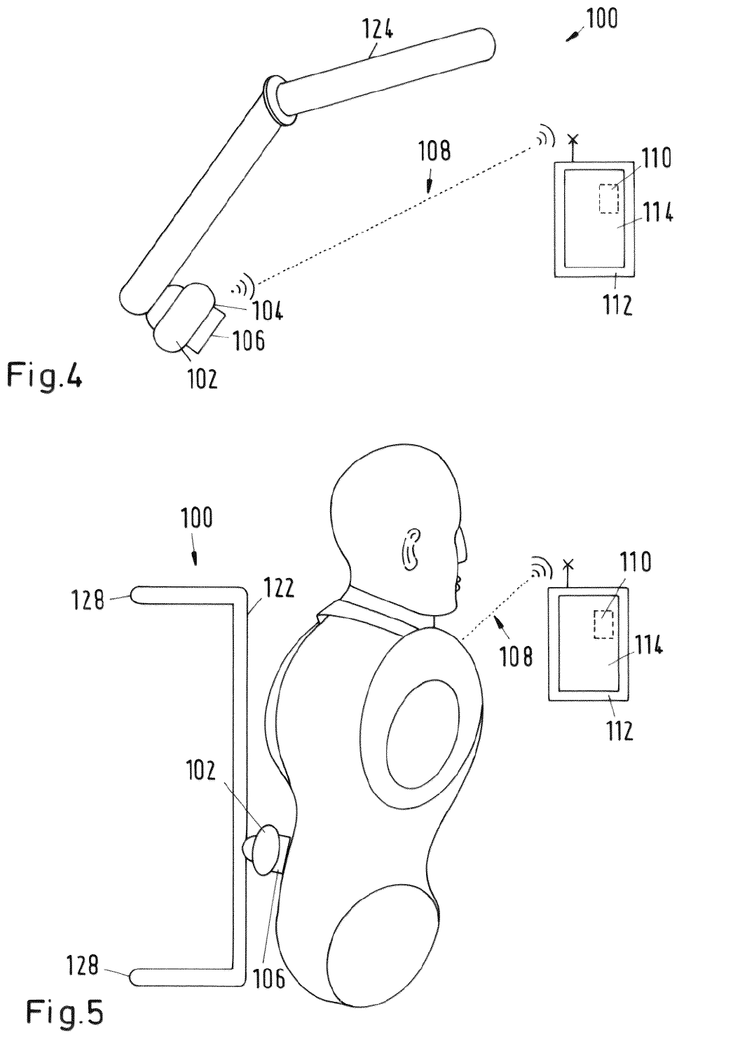

However, the head unit 102 may also be attached to a holding bracket 124, for example, as shown in FIG. 4. This holding bracket 124 may, for example, be provided with at least one joint or even more than one joint in order to provide optimal positioning of the head unit 102 relative to the user's back. It is possible that the holding bracket 124 is also formed from a thermoplastically deformable material, so that the holding bracket 124 can be individually adapted to the user's body.

FIG. 5 shows another variant of the system 100, in which the head unit 102 is movably attached to a rail 122. In the present case, the rail 122 is itself fixable or fixed to the wall by means of suction cups 128. In this case, it is possible for the head unit 102 to comprise an electric drive, which is device to adjust the head unit 102 along the rail 122. The user can press the back against the head unit 102, which then shaves or epilates. The progress of the body hair removal can be monitored on the smartphone 112. It is also possible to control the movement of the head unit 102 with the smartphone 112 in the manner of a remote control, whereby the head unit 102 can then be controlled along the rail 122 with the smartphone 112.

Overall, the present system 100 is characterized by the fact that depilation or epilation of hard-to-reach areas is performed quickly and thoroughly. The visualization on the display 114 offers the user additional convenience and ensures that all desired areas are depilated or epilated. The system 100 has proven to be multifunctional, so that it can be used, for example, with hand loops 118, a holding bracket 124 or also using a rail 122. The sensor system integrated into the head unit 102 offers maximum user comfort and ensures a high quality of depilation or epilation.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A system to remove body hair in hard-to-reach places, the system comprising:
a head unit that comprises a bearing surface for bearing against a skin;
at least one electrically operated device for depilation or epilation of the body hair being arranged on the bearing surface;
an electrical storage for the electrical supply of the device for depilation or epilation;
a communication module; and
a position sensor and/or a speed sensor integrated in the head unit,
wherein the communication module establishes a communication link with a further communication module of a control unit and to transmit data of the position sensor and/or of the speed sensor to the control unit, and
wherein the control unit detects the position of the head unit using the data of the position sensor and/or of the speed sensor and evaluates the points at which depilation or epilation has already taken place.

2. The system according to claim 1, wherein the control unit is a component of or is a smartphone or a tablet, and wherein the smartphone or the tablet is set up to output the detected positions on a display of the smartphone or the tablet.

3. The system according to claim 2, wherein the smartphone or the tablet comprises a camera, and wherein the control unit is arranged to output detected positions of the head unit superimposed over an image of the user's back captured by the camera.

4. The system according to claim 3, wherein the control unit is arranged to determine a progress of depilation or epilation based on the image and based on the position data, and wherein the display is arranged to display the progress graphically.

5. The system according to claim 1, wherein a pressure sensor is assigned to the device for depilation or for epilation, and wherein the control unit evaluates a contact pressure during depilation or epilation.

6. The system according to claim 1, wherein the head unit with its bearing surface has a shape of a flattened or elongated ellipsoid of revolution.

7. The system according to claim 1, wherein a plurality of electrically operated devices for depilation or epilation are integrated into the head unit, and wherein the devices are arranged offset to each other.

8. The system according to claim 1, wherein two holding straps are attached to the head unit.

9. The system according to claim 8, wherein a clamping bracket is attached to the head unit, which rigidly connects two ends of the holding straps attached to the head unit.

10. The system according to claim 1, wherein the head unit comprises an electric drive that is arranged to adjust the head unit along a rail.
